(19) United States
(12) Patent Application Publication
(10) Pub. No.: US 2026/0170177 A1
(43) Pub. Date: Jun. 18, 2026

(54) ADAPTIVE DATA PIPELINES ENABLING SECURE DATA TRANSFERS

(71) Applicant: Goldman Sachs & Co. LLC, New York, NY (US)

(72) Inventors: Balasubramanian Sakthivel, Plainsboro, NJ (US); Jeremy Tyrrell, Southlake, TX (US); Belinda Anne Neal, New York, NY (US); Jawad Jamal Abdussalam, Dallas, TX (US); Tyana Akpan, Dallas, TX (US)

(21) Appl. No.: 19/390,096

(22) Filed: Nov. 14, 2025

Related U.S. Application Data
(60) Provisional application No. 63/735,619, filed on Dec. 18, 2024.

(51) Int. Cl. G06F 21/62; H04L 9/40

(52) U.S. Cl. CPC G06F 21/6254; H04L 63/04

(57) ABSTRACT

A method includes obtaining a dataset and identifying a sensitivity level associated with the dataset. The method also includes dynamically selecting, based on the sensitivity level and additional information associated with the dataset, at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data. In addition, the method includes applying the at least one of the scanning technique, the masking technique, and the data synthesis technique during generation of an anonymized dataset, where the anonymized dataset lacks the sensitive information.

### CROSS-REFERENCE TO RELATED APPLICATION AND PRIORITY CLAIM

This application claims priority under 35 U.S.C. § 119(e) to U.S. Provisional Patent Application No. 63/735,619 filed on Dec. 18, 2024, which is hereby incorporated by reference in its entirety.

### TECHNICAL FIELD

This disclosure is generally directed to communication and security systems and processes. More specifically, this disclosure is directed to adaptive data pipelines enabling secure data transfers.

### BACKGROUND

In today's data-driven environment, there is an increasing need for secure and compliant methods to transfer sensitive data from internal networks to external environments or other destinations, such as sandboxes, for testing and development purposes. One example of this is during the retooling or retraining of artificial intelligence/machine learning (AI/ML) models, such as when performing proof of concept (POC) testing with vendors. When retooling or retraining AI/ML models, large amounts of data may need to be transferred to external systems or other destinations. However, this can be challenging when the data to be transferred includes or potentially includes personally-identifiable information (PII), medical data, financial data, or other sensitive data.

### SUMMARY

This disclosure relates to adaptive data pipelines enabling secure data transfers.

In a first embodiment, a method includes obtaining a dataset and identifying a sensitivity level associated with the dataset. The method also includes dynamically selecting, based on the sensitivity level and additional information associated with the dataset, at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data. In addition, the method includes applying the at least one of the scanning technique, the masking technique, and the data synthesis technique during generation of an anonymized dataset, where the anonymized dataset lacks the sensitive information.

In a second embodiment, an apparatus includes at least one processing device configured to obtain a dataset and identify a sensitivity level associated with the dataset. The at least one processing device is also configured to dynamically select, based on the sensitivity level and additional information associated with the dataset, at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data. The at least one processing device is further configured to apply the at least one of the scanning technique, the masking technique, and the data synthesis technique during generation of an anonymized dataset, where the anonymized dataset lacks the sensitive information.

In a third embodiment, a non-transitory computer readable medium contains instructions that when executed cause at least one processor to obtain a dataset and identify a sensitivity level associated with the dataset. The non-transitory computer readable medium also contains instructions that when executed cause the at least one processor to dynamically select, based on the sensitivity level and additional information associated with the dataset, at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data. The non-transitory computer readable medium further contains instructions that when executed cause the at least one processor to apply the at least one of the scanning technique, the masking technique, and the data synthesis technique during generation of an anonymized dataset, wherein the anonymized dataset lacks the sensitive information.

Any single one or any combination of the following features may be used with the first, second, or third embodiment.

All of the scanning technique, the masking technique, and the data synthesis technique may be dynamically selected based on the sensitivity level and the additional information associated with the dataset. In some cases, the scanning technique, the masking technique, and the data synthesis technique may be dynamically selected using multiple machine learning models. Also, in some cases, the machine learning models may be configured to select one or more sensitivity parameters for each of the scanning technique, the masking technique, and the data synthesis technique.

After at least one of the scanning technique, the masking technique, and the data synthesis technique is selected and used to process the dataset, feedback may be received to adjust at least one of the scanning technique, the masking technique, and the data synthesis technique. Also, at least one of the anonymized dataset, a scanned dataset, or a masked dataset may be updated.

The additional information associated with the dataset may include at least one of: a context in which the dataset will be used, including a type of application and a location; dataset details, including a size of the dataset and a complexity of the dataset; constraints, including a processing speed requirement, whether a cost constraint exists, and whether the synthetic data needs to retain statistical significance; and any known sensitivity of the dataset.

The anonymized dataset may be communicated to an external destination. The external destination may be outside a computing environment in which the dataset is stored.

The scanning technique may be selected from a set of scanning techniques that includes keyword-based scanning, pattern matching, heuristic-based scanning, natural language processing-based scanning, and differential privacy scanning.

The masking technique may be selected from a set of masking techniques that includes simple substitution masking, truncation masking, non-salted hashing masking, salted hashing masking, generalization masking, tokenization masking, dynamic data masking, differential privacy masking, and synthetic data generation masking.

The data synthesis technique may be selected from a set of data synthesis techniques that includes shuffling data synthesis, noise injection data synthesis, data generalization data synthesis, attribute swapping data synthesis, synthetic data generation data synthesis, differential privacy scanning data synthesis, and generative adversarial network (GAN)-based data synthesis.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting adaptive data pipelines enabling secure data transfers according to this disclosure;

FIG. 2 illustrates an example device supporting adaptive data pipelines enabling secure data transfers according to this disclosure;

FIG. 3 illustrates an example functional architecture supporting adaptive data pipelines enabling secure data transfers according to this disclosure;

FIGS. 4 through 9 illustrate example tables summarizing operations of the functional architecture of FIG. 3 according to this disclosure; and

FIG. 10 illustrates an example method for using an adaptive data pipeline to enable a secure data transfer according to this disclosure.

### DETAILED DESCRIPTION

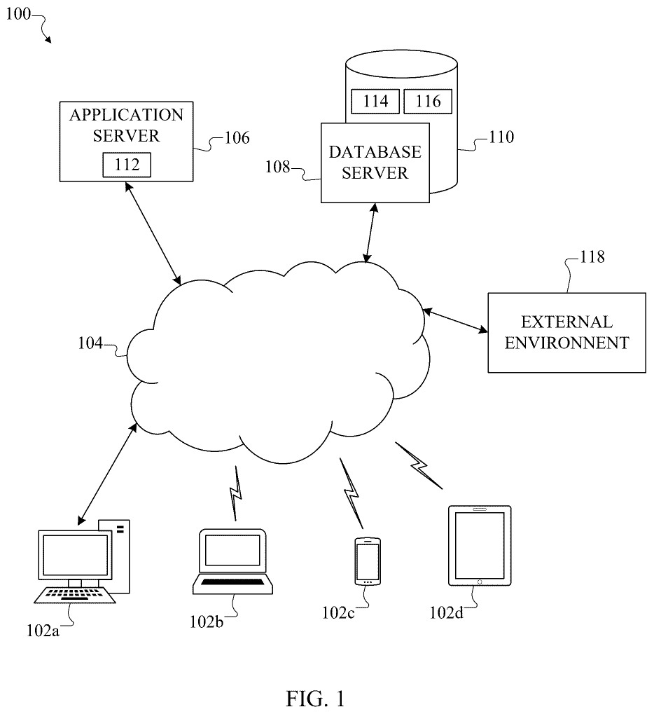

FIGS. 1 through 10, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, in today's data-driven environment, there is an increasing need for secure and compliant methods to transfer sensitive data from internal networks to external environments or other destinations, such as sandboxes, for testing and development purposes. One example of this is during the retooling or retraining of artificial intelligence/machine learning (AI/ML) models, such as when performing proof of concept (POC) testing with vendors. When retooling or retraining AI/ML models, large amounts of data may need to be transferred to external systems or other destinations. However, this can be challenging when the data to be transferred includes or potentially includes personally-identifiable information (PII), medical data, financial data, or other sensitive data. Traditional methods either lack the flexibility needed for varying sensitivity levels or incur high costs by applying overly-conservative techniques across the board.

This disclosure provides techniques supporting adaptive data pipelines enabling secure data transfers, such as to external environments or other destinations. As described in more detail below, a dataset can be obtained, and a sensitivity level associated with the dataset can be identified. Based on the sensitivity level and additional information associated with the dataset, at least one of a scanning technique that defines how the dataset is scanned for sensitive information to be removed, a masking technique that defines how the sensitive information is to be removed, and a data synthesis technique that defines how the sensitive information is to be replaced with synthetic data can be dynamically selected. The at least one of the scanning technique, the masking technique, and the data synthesis technique can be applied during generation of an anonymized dataset, where the anonymized dataset lacks the sensitive information.

In this way, the described techniques can be used to support a self-adjusting pipeline. The pipeline can obtain one or more datasets to be transferred and can dynamically select scanning, masking, and/or synthesis techniques to be used to modify the one or more datasets prior to transfer to an external environment or other destination. In some cases, the scanning, masking, and synthesis techniques can be dynamically selected based on user inputs and/or automated assessments, and feedback (optionally with a “human in the loop”) can be used to adjust the scanning sensitivity and/or the masking or synthesis selection. In some embodiments, an orchestrator, such as one containing multiple AI/ML models, can be used for optimizing selection of the scanning, masking, and synthesis techniques and sensitivity parameters for each.

These techniques therefore support an effective solution that can dynamically adjust data processing operations (such as classification, scanning, masking, and synthesis) based on real-time sensitivity assessments to maintain compliance while optimizing resource usage. These approaches can ensure that data remains protected at every stage while reducing or minimizing resources and/or costs associated with advanced security measures. An effective data pipeline can be used to transfer sensitive data, such as from an internal network to an external sandbox or other destination, for testing or other use while dynamically ensuring compliance through adaptive data classification, scanning, masking, and synthesis operations based on real-time sensitivity assessments. Context-aware adaptive approaches that optimize the selection of techniques for efficiency and compliance (and optionally other factors like cost-effectiveness) can be used while preserving privacy through various advanced data synthesis and privacy-preserving mechanisms. Specific examples of advantages or benefits of the described techniques may include increased processing speeds, improved data privacy, improved data security and enhanced compliance surrounding transfers of sensitive data to external environments or other destinations, improved automation and streamlined workflow management, reduced risks associated with transfers of sensitive data to external environments or other destinations, and/or improved cost efficiencies associated with running proof of concept (POC) or other testing. Overall, these techniques can be used to generate anonymized datasets that can be transferred to external destinations or other destinations with reduced risks.

FIG. 1 illustrates an example system 100 supporting adaptive data pipelines enabling secure data transfers according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network(s) 104. Communications between each user device 102a-102d and at least one network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information, such as devices that can transmit user input regarding datasets to be processed and anonymized and that can receive information for review during the anonymization process.

The at least one network 104 facilitates communication between various components of the system 100. For example, the network(s) 104 may communicate Internet Protocol (IP) packets, frame relay frames, Asynchronous Transfer Mode (ATM) cells, or other suitable information between network addresses. The network(s) 104 may include one or more local area networks (LANs), metropolitan area networks (MANs), wide area networks (WANs), all or a portion of a global network such as the Internet, or any other communication system or systems at one or more locations. The network(s) 104 may also operate according to any appropriate communication protocol or protocols.

The application server 106 is coupled to the at least one network 104 and is coupled to or otherwise communicates with the database server 108. The application server 106 supports various functions related to adaptive data pipelines enabling secure data transfers to external environments or other destinations. For example, the application server 106 may include one or more applications 112 that implement at least one pipeline that can process one or more datasets 114 and generate one or more anonymized datasets 116. In some embodiments, for instance, the at least one pipeline may select a scanning technique, a masking technique, and/or a data synthesis technique to be applied to at least one dataset 114 in order to generate at least one anonymized dataset 116. The selected scanning technique may define how a dataset 114 is scanned for sensitive information to be removed. The selected masking technique may define how the sensitive information is to be removed. The selected data synthesis technique may define how the sensitive information is to be replaced with synthetic data that can be dynamically selected or generated. Details of how an example pipeline could be implemented are provided below.

Each anonymized dataset 116 may be used in any suitable manner. In some embodiments, one or more anonymized datasets 116 may be provided to at least one external environment 118. Each external environment 118 may represent a computing system or other system that is separate from the system 100 and potentially operated by a different operator than the system 100. As a particular example, an external environment 118 may represent a computing system or other system in which an AI/ML model is being trained, retrained, or retooled. Note, however, that the system 100 may be used with any other suitable external environment(s) 118. Also note that one or more anonymized datasets 116 may be provided to any other or additional destination(s), including one or more destinations that are internal within the system 100.

The database server 108 operates to store and facilitate retrieval of various information used, generated, or collected by the application server 106 and the user devices 102a-102d in the database 110. For example, the database server 108 may store the various datasets 114, 116. While the database server 108 and database 110 are shown here as being separate from the application server 106, the application server 106 may itself incorporate the database server 108 and the database 110.

Although FIG. 1 illustrates one example of a system 100 supporting adaptive data pipelines enabling secure data transfers, various changes may be made to FIG. 1. For example, the system 100 may include any number of user devices 102a-102d, networks 104, application servers 106, database servers 108, databases 110, applications 112, datasets 114 and 116, and external environments 118. Also, these components may be located in any suitable locations and might be distributed over a large area. In addition, while FIG. 1 illustrates one example operational environment in which adaptive data pipelines enabling secure data transfers to external environments or other destinations may be used, this functionality may be used in any other suitable system. For instance, it is possible for users to use the user devices 102a-102d within a company or other organization's private network and to interact with applications 112 or other logic in cloud-based systems (such as AMAZON WEB SERVICES) or other remote systems that implement adaptive data pipelines, such as cloud-based systems in which multiple layers of applications 112 or other logic are used. The multiple layers of applications 112 or other logic could include applications/logic for identifying sensitivity levels associated with datasets, dynamically selecting scanning/masking/data synthesis technique(s), applying the scanning/masking/data synthesis technique(s) to generate anonymized datasets, and storing/outputting/using the anonymized datasets. Other functions may also be supported, such as networking, security, telemetry/monitoring, and policy publication.

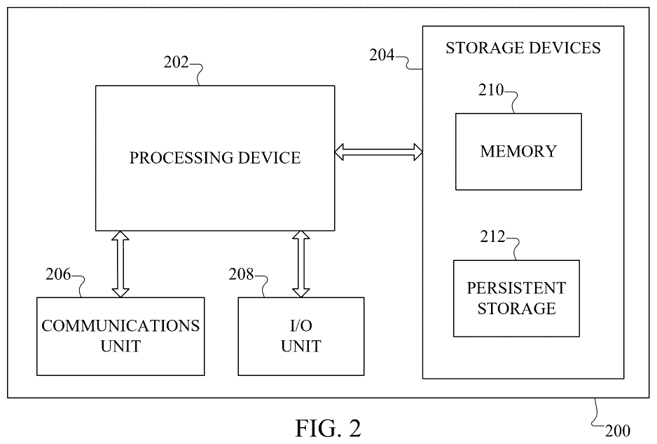

FIG. 2 illustrates an example device 200 supporting adaptive data pipelines enabling secure data transfers according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), graphics processing units (GPUs), neural processing units (NPUs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement or support the use of the application(s) 112. Thus, for example, the instructions executed by the processing device 202 may cause the device 200 to obtain one or more datasets 114 and select a scanning technique, a masking technique, and/or a data synthesis technique to be applied to one or more datasets 114 in order to generate one or more anonymized datasets 116.

Although FIG. 2 illustrates one example of a device 200 supporting adaptive data pipelines enabling secure data transfers, various changes may be made to FIG. 2. For example, computing and communication devices and systems come in a wide variety of configurations, and FIG. 2 does not limit this disclosure to any particular computing or communication device or system.

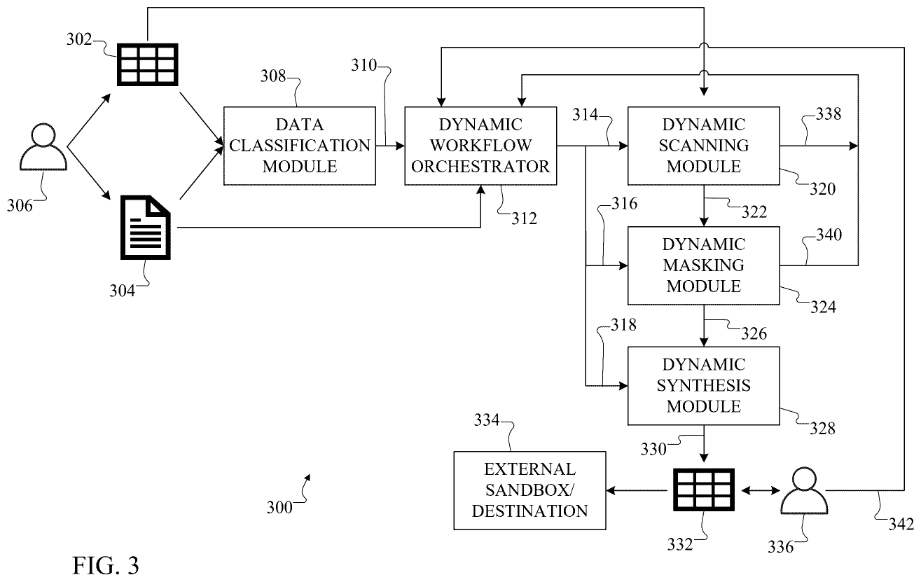

FIG. 3 illustrates an example functional architecture 300 supporting adaptive data pipelines enabling secure data transfers according to this disclosure. For ease of explanation, the functional architecture 300 of FIG. 3 is described as being implemented using the application server 106 in the system 100 of FIG. 1, where the application server 106 is implemented using one or more instances of the device 200 of FIG. 2. However, the functional architecture 300 may be implemented using any other suitable device(s) and in any other suitable system(s).

As shown in FIG. 3, the functional architecture 300 generally operates to obtain and process datasets 302 and associated context/intent details 304. Each dataset 302 represents any suitable collection of data, such as data that is intended to be sent to an external destination after processing in order to ensure that the data does not include sensitive information. Examples of sensitive information that might raise concerns can include personally-identifiable information (PII), medical data, financial data, or other sensitive data. Each dataset 302 may be obtained from any suitable source(s), such as from one or more databases 110, one or more user devices 102a-102d, or other internal source(s) or on-premises network(s).

Each set of context/intent details 304 contains information related to the associated dataset 302. For example, each set of context/intent details 304 may include one or more optimization factors and one or more constraints related to the associated dataset 302. The one or more optimization factors can relate to characteristics of the associated dataset 302 itself or an intended use of the associated dataset 302. As examples, the one or more optimization factors may identify the context of the associated dataset 302 (meaning how the associated dataset 302 will be used) and details of the associated dataset 302. In some cases, the context could identify how an application will use the associated dataset 302, such as whether an application will be downloading the associated dataset 302 (higher risk) or using in-memory visualization (lower risk). The context could also identify a target location for the associated dataset 302, such as whether the associated dataset 302 will be used with an external software-as-a-service (SAAS) product (higher risk) or stored in a local data warehouse (lower risk). The details of the associated dataset 302 could relate to characteristics like the size of the associated dataset 302 (such as when based on the number of rows and columns of data in the associated dataset 302) and the complexity of the associated dataset 302 (such as when based on the lengths of the fields of data in the associated dataset 302).

The one or more constraints can relate to characteristics of how the associated dataset 302 will be processed by the functional architecture 300. As examples, the one or more constraints may identify any known requirements or constraints and any known sensitivities of the associated dataset 302. The known requirements or constraints may include any processing speed requirements (such as whether an anonymized dataset needs to be generated within a specified timeframe), cost constraints (such as whether an anonymized dataset needs to be generated within a specified cost budget), and whether an anonymized dataset needs to retain statistical significance of its data (such as noise statistics). The last constraint type (statistical significance) can be relevant in some use cases, such as when AI/ML models are being trained, retrained, or retooled and training data needs to have certain noise characteristics or other statistical properties. The known sensitivities may include an indication whether the associated dataset 302 is known to have a low sensitivity or represents/contains public research data or other known or available data (which means there may be little or no need for any significant additional processing of the dataset 302). These types of constraints can have an impact on how subsequent processing occurs for the associated dataset 302.

Each set of context/intent details 304 may be obtained from any suitable source(s) and in any suitable manner, such as from one or more users 306 or determined automatically (like when the size and complexity of a dataset 302 can be automatically detected). In some cases, at least some of the information in each set of context/intent details 304 may be obtained or stored using a dataset intake form, which may be at least partially populated by one or more users 306 and/or at least partially populated automatically.

A data classification module 308 generally operates to process each dataset 302 and/or its associated context/intent details 304 in order to generate a real-time data sensitivity score 310 for the dataset 302. For example, the data classification module 308 can analyze the data contained in each dataset 302 and analyze the associated information from the context/intent details 304 for that dataset 302 in order to identify an initial sensitivity level for the dataset 302 as the real-time data sensitivity score 310 for the dataset 302. In some cases, the initial sensitivity level may be selected from among multiple predefined sensitivity levels, such as when the initial sensitivity level could be selected from among a low sensitivity, a medium sensitivity, a high sensitivity, and a maximum sensitivity. In other cases, the data classification module 308 may generate numerical real-time data sensitivity scores 310 or other types of scores for the datasets 302. In general, the data classification module 308 can be used to generate any suitable data classifications that identify the sensitivities of the datasets 302.

The data classification module 308 includes any suitable logic configured to identify sensitivities for datasets 302. In some embodiments, for example, the data classification module 308 may represent or include one or more machine learning models that have been trained to process datasets and associated information in order to identify sensitivities or sensitivity scores for the datasets. For instance, the one or more machine learning models may be trained by providing known datasets and associated information to the machine learning model(s) and comparing estimated sensitivities/sensitivity scores output by the machine learning model(s) to desired or ground truth sensitivities/sensitivity scores. Weights or other parameters of the machine learning model(s) can be adjusted during the training until the machine learning model(s) can generate estimated sensitivities/sensitivity scores that match the ground truth sensitivities/sensitivity scores (at least to within a desired degree of accuracy). In some cases, the data classification module 308 may leverage a prior data classification of a dataset 302 (if one is available), such as a data classification from a user or other system. Also, in some cases, the data classification module 308 can use feedback to adjust sensitivity thresholds or otherwise modify how datasets 302 are classified over time.

In some embodiments, the data classification module 308 may provide real-time data sensitivity scores 310 to one or more human users, such as one or more technology risk officers or other personnel, for manual review and validation. Among other things, this can provide a “human in the loop,” meaning at least one person can review and confirm whether each real-time data sensitivity score 310 appears to accurately characterize the sensitivity of the associated dataset 302. If not, a manual adjustment can be made to the real-time data sensitivity score 310, the data classification module 308 can rerun its analysis using additional information, or other suitable action(s) may occur.

A dynamic workflow orchestrator 312 generally operates to process the sets of context/intent details 304 for the datasets 302 and the real-time data sensitivity scores 310 for the datasets 302 in order to select how each dataset 302 may be subsequently processed. For example, the dynamic workflow orchestrator 312 can process its inputs in order to generate a scanning selection 314, a masking selection 316, and/or a synthesis selection 318. The scanning selection 314 can represent a selection of at least one of multiple scanning techniques that could be applied to a given dataset 302. The masking selection 316 can represent a selection of at least one of multiple masking techniques that could be applied to a given dataset 302. The synthesis selection 318 can represent a selection of at least one of multiple data synthesis techniques that could be used to generate synthetic data for a given dataset 302.

The dynamic workflow orchestrator 312 can select the scanning, masking, and/or synthesis techniques in any suitable manner. For example, when selecting scanning techniques to generate scanning selections 314, the dynamic workflow orchestrator 312 may select less-advance, moderately-advanced, or highly-advanced scanning techniques depending on the sensitivity levels of the datasets 302 as represented by the real-time data sensitivity scores 310. The dynamic workflow orchestrator 312 can also consider any constraints, known scanning requirements, application usage, target location, cost inputs, etc. (possibly considering all inputs used by the data classification module 308) to select scanning techniques for datasets 302. In some cases, the dynamic workflow orchestrator 312 may leverage one or more optimization algorithms, such as a weighted scoring model, Multi-Criteria Decision Analysis (MCDA), Reinforcement Learning (RL), or Multi-Objective Optimization, when selecting scanning techniques for datasets 302.

For each dataset 302 being subjected to scanning, one or more selected scanning techniques for that dataset 302 (as identified by the scanning selection 314 for that dataset 302) can be performed by a dynamic scanning module 320. The dynamic scanning module 320 generally operates to apply one or more scanning techniques to a dataset 302 in order to generate a scanned dataset 322. Among other things, the scanned dataset 322 may be associated with an identification of sensitive data (if any) contained in the original dataset 302. The dynamic scanning module 320 can apply the selected scanning technique(s) to the dataset 302 when generating the scanned dataset 322. The selected scanning technique(s) can be used here to automatically scan the dataset 302 and identify one or more sensitive fields, attributes, or other contents of the dataset 302 that may need to be protected.

The dynamic scanning module 320 can support any suitable data scanning techniques in order to identify contents of datasets 302 that may need to be protected. For example, less-advanced scanning techniques (which can be more cost-effective) may be applied to less-sensitive datasets 302, and examples of less-advanced scanning techniques may include keyword-based scanning and pattern matching. Keyword-based scanning generally involves scanning datasets 302 to identify whether any specified keywords are present. Pattern matching (also known as “regular expression” or “regex”) generally involves scanning datasets 302 to identify whether any specified patterns of data are present. Moderately-advanced scanning techniques (which can be less cost-effective than less-advanced scanning techniques) may be applied to more-sensitive datasets 302, and examples of moderately-advanced scanning techniques may include heuristic-based scanning and machine learning-based scanning. Heuristic-based scanning generally involves scanning datasets 302 using one or more rules and/or algorithms to determine whether certain data is present. Machine learning-based scanning generally involves scanning datasets 302 using one or more trained machine learning models to determine whether certain data is present. Highly-advanced scanning techniques (which may provide better accuracy or be better for complex datasets but can be less cost-effective) may be applied to most-sensitive datasets 302, and examples of highly-advanced scanning techniques may include natural language processing (NPL)-based scanning and differential privacy scanning. NPL-based scanning generally involves scanning datasets 302 using one or more large language models (LLMs) or other machine learning models that understand natural language to determine whether certain data is present. Differential privacy scanning generally involves scanning datasets 302 to determine whether the datasets 302 contain information that would allow others to learn more about specific individuals or organizations based on the datasets 302. Note that these scanning techniques and these classifications of scanning techniques are examples only and can vary as needed or desired. For instance, other or additional types of scanning techniques may be supported. Also, additional scanning techniques are sure to be developed in the future.

In some embodiments, one or more datasets 302, 322 may undergo manual review by one or more human users, such as one or more technology risk officers or other personnel, for manual review and validation of the scanning results generated by the dynamic scanning module 320. For example, the personnel may manually review one or more datasets 302 and determine which data is sensitive and may need to be subsequently masked. A determination can also be made whether the human-generated decisions about what data may be sensitive matches with the data that the dynamic scanning module 320 identified as being sensitive. Among other things, this can provide a “human in the loop,” meaning at least one person can review and confirm whether the dynamic scanning module 320 appears to have identified sensitive information correctly. If not, a manual adjustment can be made, such as by changing how the scanned dataset 322 is generated and creating a new scanned dataset 322.

When selecting masking techniques to generate masking selections 316, the dynamic workflow orchestrator 312 may select less-advance, moderately-advanced, or highly-advanced masking techniques depending on the sensitivity levels of the datasets 302 as represented by the real-time data sensitivity scores 310. The dynamic workflow orchestrator 312 can also consider any constraints, known scanning requirements, application usage, target location, cost inputs, etc. (possibly considering all inputs used by the data classification module 308) to select masking techniques for datasets 302. In some cases, the dynamic workflow orchestrator 312 may leverage one or more optimization algorithms, such as a weighted scoring model, MCDA, RL, or Multi-Objective Optimization, when selecting masking techniques for datasets 302.

For each dataset 302 being subjected to masking (such as when the dataset 302 contains sensitive data as identified by the dynamic scanning module 320 or identified in some other manner), one or more selected masking techniques for that dataset 302 (as identified by the masking selection 316 for that dataset 302) can be performed by a dynamic masking module 324. The dynamic masking module 324 may also receive a scanned dataset 322 corresponding to that dataset 302. The dynamic masking module 324 generally operates to obscure or remove sensitive data in order to generate a masked dataset 326. For example, the selected masking technique(s) can be used here to automatically obscure or remove one or more sensitive fields, attributes, or other contents from the dataset 302 or the scanned dataset 322.

The dynamic masking module 324 can support any suitable data masking techniques in order to protect contents of the dataset 302 or 322. For example, less-advanced masking techniques (which can be more cost-effective) may be applied to less-sensitive datasets 302 or 322, and examples of less-advanced masking techniques may include simple substitution, truncation, and non-salted hashing. Simple substitution generally involves replacing specified data with other (possibly random) data. Truncation generally involves removing a portion of data. Non-salted hashing generally involves replacing specified data with hash values for that data, where the hash values are generated without salt (meaning the hash values are generated without using random data added to the specified data). Moderately-advanced masking techniques (which can be less cost-effective than less-advanced masking techniques) may be applied to more-sensitive datasets 302, and examples of moderately-advanced masking techniques may include salted hashing, generalization, and tokenization. Salted hashing generally involves replacing specified data with hash values for that data, where the hash values are generated with salt (meaning the hash values are generated using random data added to the specified data). Generalization generally involves replacing specified data with broader categories or ranges of data, making the specified data less identifiable but still useful for analysis. Tokenization generally involves replacing specified data with symbols or tokens, which could still uniquely identify the specified data. Highly-advanced masking techniques (which may provide better accuracy or be better for complex datasets but can be less cost-effective) may be applied to most-sensitive datasets 302, and examples of highly-advanced masking techniques may include dynamic data masking (DDM), differential privacy, and synthetic data generation. DDM generally involves replacing specified data with fictitious (yet realistic) data. Differential privacy generally involves adding noise to specified data, such as by replacing numerical values with similar numerical values randomly within certain ranges of the numerical values. Synthetic data generation generally involves replacing specified data with similar but synthetic (artificially-generated) data. Note that these masking techniques and these classifications of masking techniques are examples only and can vary as needed or desired. For instance, other or additional types of masking techniques may be supported. Also, additional masking techniques are sure to be developed in the future.

In some embodiments, one or more masked datasets 326 may undergo manual review by one or more human users, such as one or more technology risk officers or other personnel, for manual review and validation of the masking results generated by the dynamic masking module 324. For example, the personnel may manually review one or more masked datasets 326 and determine whether the one or more masked datasets 326 meet compliance requirements or other requirements, such as by suitably masking all sensitive data that should be masked. Among other things, this can provide a “human in the loop,” meaning at least one person can review and confirm whether the dynamic masking module 324 appears to have masked sensitive information correctly. If not, a manual adjustment can be made, such as by changing how the dataset 302 or 322 is masked and creating a new masked dataset 326.

When selecting synthesis techniques to generate synthesis selections 318, the dynamic workflow orchestrator 312 may select less-advance, moderately-advanced, or highly-advanced synthesis techniques depending on the sensitivity levels of the datasets 302 as represented by the real-time data sensitivity scores 310. The dynamic workflow orchestrator 312 can also consider any constraints, known scanning requirements, application usage, target location, cost inputs, etc. (possibly considering all inputs used by the data classification module 308) to select synthesis techniques for datasets 302. In some cases, the dynamic workflow orchestrator 312 may leverage one or more optimization algorithms, such as a weighted scoring model, MCDA, RL, or Multi-Objective Optimization, when selecting synthesis techniques for datasets 302.

For each dataset 302 being subjected to synthesis (such as when the dataset 302 contains sensitive data that has been masked by the dynamic masking module 324 or identified in some other manner), one or more selected synthesis techniques for that dataset 302 (as identified by the synthesis selection 318 for that dataset 302) can be performed by a dynamic synthesis module 328. The dynamic synthesis module 328 may also receive a scanned dataset 322 or masked dataset 326 corresponding to that dataset 302. The dynamic synthesis module 328 generally operates to create and add synthetic data to a dataset in order to generate a synthetic dataset 330, which typically contains both (i) some data from the original dataset 302 and (ii) synthetic data (although the proportions of original data and synthetic data may vary widely). For example, the selected synthesis technique(s) can be used here to automatically generate synthetic data to replace one or more masked sensitive fields, attributes, or other contents from the dataset 302, scanned dataset 322, or masked dataset 326.

The dynamic synthesis module 328 can support any suitable data synthesis techniques in order to generate synthetic contents to replace contents of the dataset 302, 322, 326 that may need to be protected. For example, less-advanced synthesis techniques (which can be more cost-effective) may be applied to less-sensitive datasets 302, 322, 326, and an example of less-advanced synthesis techniques may include shuffling. Shuffling generally involves reordering or rearranging specified data within a dataset. Moderately-advanced synthesis techniques (which can be less cost-effective than less-advanced synthesis techniques) may be applied to more-sensitive datasets 302, and examples of moderately-advanced synthesis techniques may include noise injection, data generalization, and attribute swapping. Noise injection generally involves adding additional data (noise) to a dataset. Data generalization generally refers to summarizing or generalizing data in a dataset, such as by replacing lower-level values with higher-level concepts. Attribute swapping generally involves swapping or exchanging attribute values between various fields of a dataset, thereby keeping the data but obscuring the relationships between the data. Highly-advanced synthesis techniques (which may provide better accuracy or be better for complex datasets but can be less cost-effective) may be applied to most-sensitive datasets 302, and examples of highly-advanced synthesis techniques may include synthetic data generation, differential privacy, and GAN-based data synthesis. Synthetic data generation generally involves replacing specified data with similar but synthetic (artificially-generated) data. Differential privacy generally involves adding noise according to a desired distribution to the data of a dataset. GAN-based data synthesis generally involves using a generative adversarial network to generate data that a discriminator is unable to effectively differentiate from real data in a dataset. Note that these synthesis techniques and these classifications of synthesis techniques are examples only and can vary as needed or desired. For instance, other or additional types of synthesis techniques may be supported. Also, additional synthesis techniques are sure to be developed in the future.

In some embodiments, one or more synthetic datasets 330 may undergo manual review by one or more human users, such as one or more technology risk officers or other personnel, for manual review and validation of the synthesis results generated by the dynamic synthesis module 328. For example, the personnel may manually review one or more synthetic datasets 330 and determine whether the one or more synthetic datasets 330 meet compliance requirements or other requirements, such as by suitably hiding/replacing all sensitive data that should be replaced. Among other things, this can provide a “human in the loop,” meaning at least one person can review and confirm whether the dynamic synthesis module 328 appears to have generated synthetic information correctly. If not, a manual adjustment can be made, such as by changing how the synthetic data is generated and creating a new synthetic dataset 330.

Note that it is possible for zero, one, two, or all three of the modules 320, 324, 328 to be applied for any given dataset 302. For example, when a dataset 302 contains public information or otherwise has a lowest sensitivity, the dataset 302 may not require any processing, and the dataset 302 could be output as an anonymized dataset 332 without modification. If a dataset has one of possibly multiple higher sensitivities, the dataset 302 may be processed using one, two, or all three of the modules 320, 324, 328. In some cases, it may be possible for the functional architecture 300 to receive certain information (such as a scanned dataset 322 or a masked dataset 326) from an external source, so one or more of the modules 320, 324, 328 may not be needed when generating an anonymized dataset 332. Ideally, the anonymized dataset 332 that is produced for a given dataset 302 lacks sensitive information contained in the dataset 302.

Each anonymized dataset 332 that is generated here may be used in any suitable manner. For example, an anonymized dataset 332 may be transferred (such as via a secure communication link) to at least one external sandbox/destination 334. The external sandbox/destination 334 represents a destination in which the anonymized dataset 332 may be accessed or used, such as by users or other systems. Each anonymized dataset 332 may also be provided to one or more users 336 for review and approval. Again, this can provide a “human in the loop” and allows the one or more users 336 to review each anonymized dataset 332 and verify whether each anonymized dataset 332 meets compliance requirements or other requirements. In some cases, approval by one or more users 336 may be needed before an anonymized dataset 332 can be transferred to an external sandbox/destination 334.

The dynamic workflow orchestrator 312 can select one or more scanning techniques, one or more masking techniques, and/or one or more synthesis techniques in any suitable manner. For example, in some embodiments, the dynamic workflow orchestrator 312 may include one or more machine learning models that have been trained to process context/intent details 304, real-time data sensitivity scores 310, and/or other information in order to select scanning, masking, and/or synthesis techniques. As a particular example, the one or more machine learning models may be trained by providing known context/intent details 304, real-time data sensitivity scores 310, and possibly other information to the machine learning model(s) and comparing selected scanning, masking, and/or synthesis techniques to desired or ground truth techniques. Weights or other parameters of the machine learning model(s) can be adjusted during the training until the machine learning model(s) can select scanning, masking, and/or synthesis techniques that match the ground truth techniques (at least to within a desired degree of accuracy). In some embodiments, the dynamic workflow orchestrator 312 may include three machine learning models, one for each of dynamic scanning selection, dynamic masking selection, and dynamic synthesis selection. Also, in some embodiments, the machine learning model(s) or other logic can be used to select sensitivity parameters for each of the scanning, masking, and synthesis techniques. The sensitivity parameters can control how different data sensitivities (such as those determined by the data classification module 308) translate to different scanning, masking, and synthesis techniques.

In some cases, various types of feedback can be used to adjust how the dynamic workflow orchestrator 312 selects scanning, masking, and synthesis techniques. For example, feedback 338 can be used to indicate whether one or more users approve or disapprove of how a dataset 302 was scanned. In some cases, for instance, the feedback 338 may represent an updated real-time data sensitivity score that alters the real-time data sensitivity score 310 for the associated dataset 302. As another example, the feedback 338 may represent an identification of how much or what types of sensitive data (if any) are located by the selected scanning technique. This feedback 338 may be used to cause the dynamic workflow orchestrator 312 to select a different scanning/masking/synthesis technique, such as one providing higher-quality or more-advanced scanning/masking/synthesis. Also or alternatively, this feedback 338 may be used to cause the dynamic scanning module 320 to automatically select and perform a higher-quality or more-advanced scanning technique.

Similarly, feedback 340 can be used to indicate whether one or more users approve or disapprove of how a dataset 302 or 322 was masked. In some cases, for instance, the feedback 340 may represent an updated real-time data sensitivity score that alters the real-time data sensitivity score 310 for the associated dataset 302. As another example, the feedback 340 may represent an identification that some data in a dataset 302 or 322 was not classified as being sensitive information and should have been. This feedback 340 may be used to cause the dynamic workflow orchestrator 312 to select a different scanning/masking/synthesis technique, such as one providing higher-quality or more-advanced scanning/masking/synthesis. Also or alternatively, this feedback 340 may be used to cause the dynamic masking module 324 to automatically select and perform a higher-quality or more-advanced masking technique.

In addition, feedback 342 can be used to indicate whether one or more users 336 approve or disapprove of an anonymizer dataset 332 (effectively providing an indication of how well a dataset 302, 322, 326 was further anonymized using synthetic data). In some cases, for instance, the feedback 342 may represent an updated real-time data sensitivity score that alters the real-time data sensitivity score 310 for the associated dataset 302. As another example, the feedback 342 may represent an identification that some synthetic data or other data synthesis results were not generated properly. This feedback 342 may be used to cause the dynamic workflow orchestrator 312 to select a different scanning/masking/synthesis technique, such as one providing higher-quality or more-advanced scanning/masking/synthesis. Also or alternatively, this feedback 342 may be used to cause the dynamic synthesis module 328 to automatically select and perform a higher-quality or more-advanced synthesis technique.

The feedback 338-342 may be used in various ways. For example, negative feedback may be collected and used to adjust the classification/scanning sensitivity of the dynamic workflow orchestrator 312 (meaning how the dynamic workflow orchestrator 312 assigns scanning techniques to different data sensitivities) and/or the masking/synthesis selection of the dynamic workflow orchestrator 312 (meaning how the dynamic workflow orchestrator 312 selects masking and synthesis techniques). This allows real-time feedback to be integrated into the process and allows the selected scanning, masking, and/or synthesis techniques to be updated on-the-fly, such as by altering the scanning, masking, and/or synthesis techniques being used when risks escalate during the process. As a result, the functional architecture 300 can represent a self-adjusting pipeline that (i) dynamically classifies dataset sensitivity levels (such as based on user inputs and/or automated assessments) and (ii) adjusts subsequent processing operations (such as scanning, masking, and/or synthesis) in real-time to align with risk levels, compliance requirements, or other requirements. This also allows the selections made by the dynamic workflow orchestrator 312 to evolve over time. For instance, machine learning or historical analysis of flagged data can be used to create adaptive thresholds that optimize alignment to one or more policies/compliance requirements and reduce the need for manual review. As a particular example, one or more of the various types of feedback may be used to generate new training data for use in training/retraining the machine learning model(s) of the dynamic workflow orchestrator 312.

In some cases, any of these types of feedback may include user rejections of selected scanning, masking, and/or synthesis techniques. Also, in some cases, after approval of an anonymized dataset 332 by one or more users 336, the functional architecture 300 may log all changes, such as all of the feedback and/or changes made in response to the feedback. The functional architecture 300 may particularly note cases where sensitivity scores were escalated. This enables the functional architecture 300 to start with an elevated sensitivity score (such as a high sensitivity instead of a medium sensitivity) for similar datasets 302 in the future. One, some, or all of these types of feedback may be used in any given implementation.

As can be seen here, the functional architecture 300 support a novel workflow and data pipeline to move data (such as CSV files or other files) from an on-premises or other secured network to a secured external sandbox environment (such as OASES) or other environment where the data can be used for POC testing with vendors or for other purposes. In some cases, the functional architecture 300 can support an end-to-end (E2E) workflow for secure data transfers and may include one or more “human in the loop” steps. The overall workflow enables secure data transfer to an external sandbox/destination 334 with improved data security. Throughout the E2E process, real-time feedback (such as from risk officers, users, system scans, or other source(s)) can be used to adjust the workflow dynamically. For example, if data is reclassified as higher-risk during a scanning or masking process, the pipeline can automatically escalate to a higher sensitivity workflow for subsequent masking and synthesis steps. This kind of self-adjusting pipeline adds an intelligence layer, making the workflow adaptive to live risk assessments.

FIGS. 4 through 9 illustrate example tables summarizing operations of the functional architecture 300 of FIG. 3 according to this disclosure. In FIG. 4, a table 400 illustrates an example dataset intake form, which can include various information associated with a dataset 302 to be processed by the functional architecture 300. In this example, a portion 402 of the table 400 can represent the types of information included in the context/intent details 304 for a dataset 302. Here, the types of information are divided into optimization factors and constraints, which were described above. The various examples of the optimization factors and constraints were also described above. The portion 402 of the table 400 also illustrates example values (inputs) that can be assigned (such as by users or automatically) to the various optimization factors and constraints. A portion 404 of the table 400 identifies how different ones of the various optimization factors and constraints can impact the overall workflow of the functional architecture 300. A portion 406 of the table 400 identifies risk and cost scores, which can be summed or otherwise used to generate the real-time data sensitivity score 310 for the dataset 302.

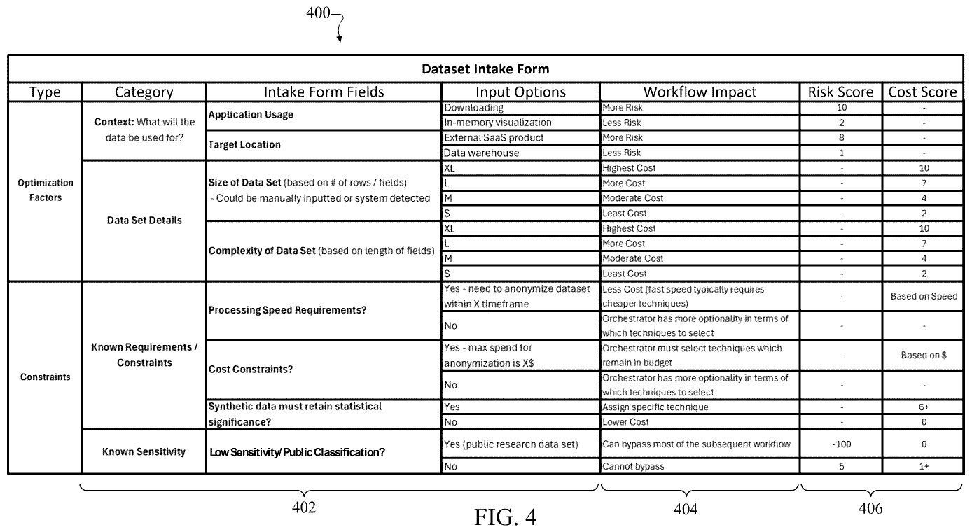

In FIG. 5, a table 500 illustrates an example definition of scanning techniques that could be supported by the dynamic scanning module 320 and selected by the dynamic workflow orchestrator 312. In this example, each scanning technique is identified by name and has an associated cost, impact on processing speed, compliance effectiveness, and data sensitivity level. As can be seen here, different scanning techniques have different costs, different processing speeds, and different effectiveness and may be useful for different data sensitivity levels. The dynamic workflow orchestrator 312 can use this information when selecting one or more scanning techniques to be performed by the dynamic scanning module 320 for a given dataset 302.

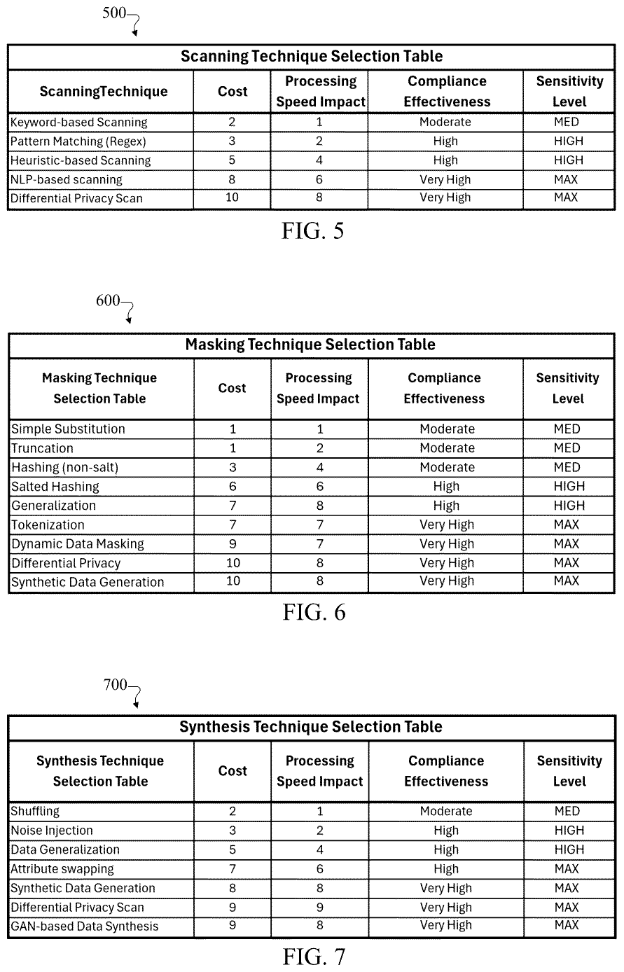

In FIG. 6, a table 600 illustrates an example definition of masking techniques that could be supported by the dynamic masking module 324 and selected by the dynamic workflow orchestrator 312. In this example, each masking technique is identified by name and has an associated cost, impact on processing speed, compliance effectiveness, and data sensitivity level. As can be seen here, different masking techniques have different costs, different processing speeds, and different effectiveness and may be useful for different data sensitivity levels. The dynamic workflow orchestrator 312 can use this information when selecting one or more masking techniques to be performed by the dynamic masking module 324 for a given dataset 302.

In FIG. 7, a table 700 illustrates an example definition of synthesis techniques that could be supported by the dynamic synthesis module 328 and selected by the dynamic workflow orchestrator 312. In this example, each synthesis technique is identified by name and has an associated cost, impact on processing speed, compliance effectiveness, and data sensitivity level. As can be seen here, different synthesis techniques have different costs, different processing speeds, and different effectiveness and may be useful for different data sensitivity levels. The dynamic workflow orchestrator 312 can use this information when selecting one or more synthesis techniques to be performed by the dynamic synthesis module 328 for a given dataset 302.

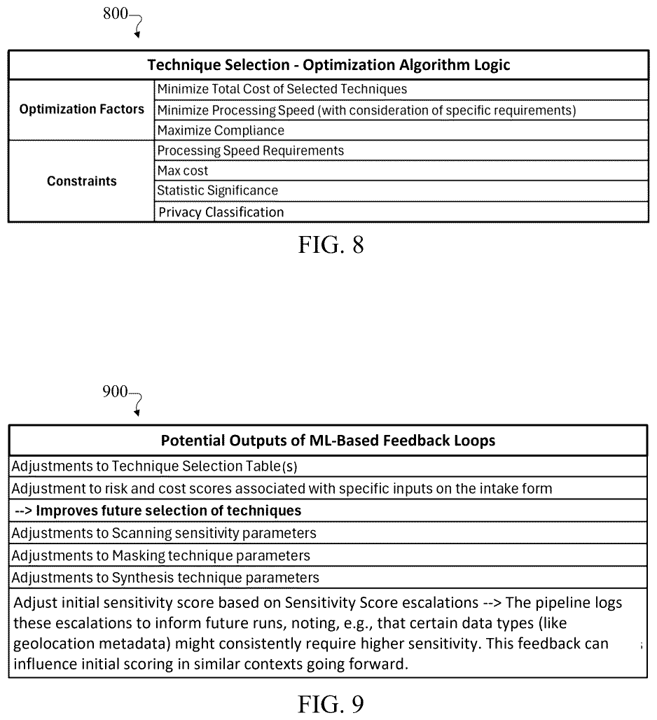

In FIG. 8, a table 800 illustrates example logic that can be used by the dynamic workflow orchestrator 312 when processing the data from the dataset intake form (the table 400) in order to select at least one scanning technique from the table 500, at least one masking technique from the table 600, and/or at least one synthesis technique from the table 700. As shown in FIG. 8, the dynamic workflow orchestrator 312 can process the optimization factors from the dataset intake form for a given dataset 302 to try and (i) minimize the total cost of the selected scanning/masking/synthesis technique(s), (ii) minimize the total processing speed of the selected scanning/masking/synthesis technique(s), and (iii) maximize compliance with applicable requirements. The dynamic workflow orchestrator 312 can process the constraints from the dataset intake form for the given dataset 302 to try and (i) comply with any specified processing speed requirements, (ii) comply with any cost constraints, (iii) maintain or not maintain statistical significance, and (iv) satisfy any known privacy classifications (such as when a user 306 specifies a known low or high data classification to be enforced). As noted above, in some cases, the dynamic workflow orchestrator 312 may use one or more trained machine learning models to select at least one scanning technique from the table 500, at least one masking technique from the table 600, and/or at least one synthesis technique from the table 700. In other embodiments, the dynamic workflow orchestrator 312 may express the selection of the scanning/masking/synthesis technique(s) as an optimization problem and solve the optimization problem using a suitable optimization algorithm.

In FIG. 9, a table 900 illustrates example ways in which the various types of feedback 338-342 may be used by the functional architecture 300. As shown here, feedback can be used to adjust one or more technique selection tables, such as one or more of the tables 500, 600, 700. For example, the feedback can be used to adjust one or more of the costs, processing speed impacts, and/or compliance effectiveness for one or more of the scanning/masking/synthesis techniques and/or to adjust the association between one or more sensitivity levels and one or more of the scanning/masking/synthesis techniques. The feedback can also or alternatively be used to adjust one or more of the risk scores and/or cost scores in the table 400. In some cases, these changes may be applied to the dataset(s) 302 currently being processed.

The various types of feedback 338-342 can also be used to control how the dynamic workflow orchestrator 312 selects scanning/masking/synthesis techniques in the future. For example, the feedback can be used to adjust one or more parameters for at least one scanning technique, masking technique, and/or synthesis technique. As a particular example, feedback may indicate that a certain scanning/masking/synthesis technique performed using given sensitivity parameters was not appropriate for a particular dataset 302, and one or more of those sensitivity parameters may be adjusted (possibly based on user input) for future datasets 302. As another example, feedback can be used to adjust a real-time data sensitivity score 310 to account for one or more escalations based on specific types of data present in a dataset 302. As a particular example, the dynamic workflow orchestrator 312 may learn that particular types of data (such as financial account information, patient health information, or geolocation data) consistently require higher sensitivity (such as based on user feedback). The dynamic workflow orchestrator 312 may increase subsequent real-time data sensitivity scores 310 for datasets 302 that contain those particular types of data.

A number of alternative or additional functions may be included in or supported by the functional architecture 300 shown in FIG. 3 depending on the implementation. For example, the ability to mask a dataset may be optimized per attribute of the dataset, meaning the dynamic masking module 324 could be configured to apply a selected masking technique per attribute (possibly allowing different masking techniques to be applied to different attributes within the same dataset 302). Similarly, the dynamic synthesis module 328 could be configured to apply a selected synthesis technique per attribute (possibly allowing different synthesis techniques to be applied to different attributes within the same dataset 302).

As another example, the functional architecture 300 may support dynamic adjustment of selected scanning, masking, and/or synthesis techniques based on data type. For instance, one or more machine learning models (such as those used in the dynamic workflow orchestrator 312) or other logic may be used to dynamically adjust the sensitivity of data classification and scanning operations based on a specific use case or expected application of data. As a particular example, certain data types (such as medical or financial data) might require different levels of scrutiny, and the functional architecture 300 could automatically adjust the scanning depth or the masking technique (such as hashing versus generalization) based on one or more predefined or other risk profiles.

As yet another example, the functional architecture 300 may be configured to select the most cost-effective masking and/or synthesis technique(s) based on the sensitivity level and real-time computational resources that are availability. Among other things, this could allow the functional architecture 300 to trade-off between the complexity of the process and the security required.

As still another example, AI/ML-driven error handling and resolution could be supported in the functional architecture 300. For example, if errors, inconsistencies, or other issues arise during execution of selected scanning, masking, and/or synthesis techniques, an AI/ML-driven error handling system or other system can attempt to resolve the issue autonomously, such as by suggesting alternate workflows, escalating to manual review, or reclassifying data based on real-time patterns.

As another example, scanning confidence scores and thresholds can be supported in the functional architecture 300. For example, a scanning confidence score could identify how confident the functional architecture 300 is that an executed scanning technique identified all sensitive data fields in a dataset 302 or if there was uncertainty around any specific field(s) in the dataset 302. A scanning confidence threshold can be applied, such as when a manual review is performed if the scanning confidence score is below the scanning confidence threshold. An AI/ML-based or other feedback loop may also be provided for optimizing future scanning performance. As a final example, a systemic re-scan process may be performed using an anonymized dataset 332 before a final manual “human in the loop” review of the anonymized dataset 332 is performed.

The following now provides a specific example of how the functional architecture 300 may be used for a given use case. Assume that an AI vendor's fraud detection capabilities are being tested, and there is a need to transfer sensitive financial transaction data securely. The functional architecture 300 may begin with a baseline sensitivity score and can dynamically update the sensitivity score based on risk or other feedback and the assessments performed at various stages within the functional architecture 300.

During initial data intake and classification, the functional architecture 300 can perform an initial context and risk assessment. In the given use case, for example, the functional architecture 300 can determine that the context involves financial transaction data for fraud detection, and an initial sensitivity score of medium (moderate) sensitivity may be determined based on the dataset's initial classification and intended use in a secure environment. The functional architecture 300 may also determine that there are one or more cost constraints (such as a desired goal of minimizing costs), so the functional architecture 300 will try to optimize resource-intensive steps. The functional architecture 300 can apply one or more baseline scanning techniques appropriate for a medium sensitivity score, but the functional architecture 300 can remain ready to escalate if higher risks are detected in subsequent operations.

During an initial scanning operation, the functional architecture 300 may initially select a keyword-based scanning technique (which is less resource-intensive) due to the moderate sensitivity score. During keyword-based scanning, the functional architecture 300 may determine that the scanning technique identifies a large percentage (such as 40%) of the dataset as including PII, financial, or other sensitive information. Based on this discovery, the functional architecture 300 can flag certain data subsets for increased scrutiny. The functional architecture 300 can also perform a sensitivity escalation mid-pipeline, meaning the functional architecture 300 can increase the real-time data sensitivity score 310 as a result of the scanning process. Here, for instance, as the functional architecture 300 flags sensitive PII or other data fields, the functional architecture 300 can automatically raise the sensitivity score for specific subsets to a high sensitivity. This triggers a switch to a more-advanced scanning technique (such as a heuristic-based scanning technique) to capture more-complex patterns and increase data protection fidelity. As a particular example of this, fields like account numbers, transaction details, and personal identifiers may now require deeper scanning techniques, so the functional architecture 300 can increase the scanning complexity and rerun scanning on at least the flagged sections of the dataset. In some cases, the escalation to a high sensitivity may prompt a technology risk officer or other personnel to review for flagged data sections, and the personnel can validate if additional security measures should be performed and confirm the high sensitivity score for these sections of the dataset.

During data masking, masking adjustments can be made based on escalated sensitivity (if present). For example, for data classified as high sensitivity, the functional architecture 300 can select a dynamic masking technique like differential privacy or synthetic data generation, which can offer a higher degree of protection compared to basic hashing. For medium sensitivity data, the data can be masked with tokenization, as this may provide an adequate level of protection without excessive resource use. However, on-the-fly masking adjustments can be made. For instance, if the functional architecture 300 detects previously-unclassified sensitive information (such as hidden fields with Social Security numbers or hidden metadata with geolocation data), the functional architecture 300 can adjust the sensitivity for these elements to maximum (very high) sensitivity. For maximum sensitivity data elements, the functional architecture 300 can use synthetic data generation to completely anonymize these fields, ensuring they are fully protected during transfer. The functional architecture 300 can log these escalations to inform future runs, noting that certain data types (such as geolocation metadata) consistently require higher sensitivity, which allows this feedback to influence initial scoring in similar contexts going forward for future datasets.

During data synthesis, further anonymization for high sensitivity may be provided. For example, maximum sensitivity data elements may be further synthesized with GAN-based synthetic data to maintain the dataset's analytical utility without exposing real identifiers. For high and medium sensitivity data, noise injection and data shuffling may be used as synthesis techniques, balancing privacy with data utility. The functional architecture 300 here can thereby adjust resource allocation based on real-time feedback, such as by using more compute resources for maximum sensitivity synthesis while keeping medium and high sensitivity processing more cost-effective. The functional architecture 300 can perform a final pass to verify that all adjustments meet the current maximum, high, and medium sensitivity levels. In some cases, a confidence score may be generated for each data segment indicating the likelihood that all sensitive fields were accurately identified and masked.

During data approval, feedback, and secure transfer, final review and approval by one or more users 336 can be performed. For example, a technology risk officer or other personnel can review the final masked and synthesized dataset, paying special attention to maximum sensitivity score fields. If a confidence score is below a defined threshold for maximum sensitivity score data, the personnel may request further adjustments. After approval, the functional architecture 300 can log all changes, including cases where sensitivity scores were escalated, which enables the functional architecture 300 to start with elevated sensitivity scores (such as high sensitivity instead of medium sensitivity) for similar datasets in the future, thereby supporting adaptive learning via one or more feedback loops. Once all reviews are complete, the functional architecture 300 can securely transfer the resulting anonymized dataset 332 to the vendor's sandbox or other external environment, thereby ensuring compliance with specified data privacy requirements and minimizing risk exposure.

The functional architecture 300 here can provide various benefits or advantages depending on the implementation. For example, the functional architecture 300 can provide an adaptive pipeline that introduces a novel way of dynamically adjusting data sensitivity scores and processing techniques based on real-time feedback, which is a technical improvement over traditional static data classification and security systems. The pipeline's multi-layered approach to data anonymization (such as by using differential privacy and/or GAN-based synthesis for high sensitivity data) provides specific concrete techniques for protecting data privacy. The functional architecture 300 here need not simply classify data but can also apply tailored security measures to that data. The adaptive nature of the functional architecture 300 allows for real-time adjustments in sensitivity scoring and processing techniques, which (among other things) enhances compliance and resource optimization. In some cases, by incorporating at least one feedback loop that refines (possibly continuously) sensitivity thresholds and processing techniques based on historical data, one or more machine learning components or other components can be employed that go beyond standard data handling methods, where the optimization process can provide a technical improvement that can be quantified and measured over time. The ability to dynamically adjust processing based on sensitivity levels and resource constraints can address specific technical challenges, such as balancing data security with processing costs, which makes the functional architecture 300 cost-effective while maintaining high compliance standards, demonstrating tangible improvements over traditional data security methods. The functional architecture 300 and the described techniques provide a concrete, step-by-step process for handling sensitive data, including specific techniques for scanning, masking, and synthesizing data based on sensitivity (optionally while balancing costs). There are a large number of real-world applications in which secure and compliant data transfers to external environments may be used, such as those involving testing in the external environments.

Although FIG. 3 illustrates one example of a functional architecture 300 supporting adaptive data pipelines enabling secure data transfers, various changes may be made to FIG. 3. For example, various components, operations, or functions in FIG. 3 may be combined, further subdivided, replicated, omitted, or rearranged and additional components, operations, or functions may be added according to particular needs. Although FIGS. 4 through 9 illustrate examples of tables 400-900 summarizing operations of the functional architecture 300 of FIG. 3, various changes may be made to FIGS. 4 through 9. For instance, the specific information/operations and types of information/operations shown in FIGS. 4 through 9 are examples meant to illustrate how different functions in the functional architecture 300 may be performed. The specific details shown in FIGS. 4 through 9 are for illustration and explanation only and could easily vary depending on the implementation.

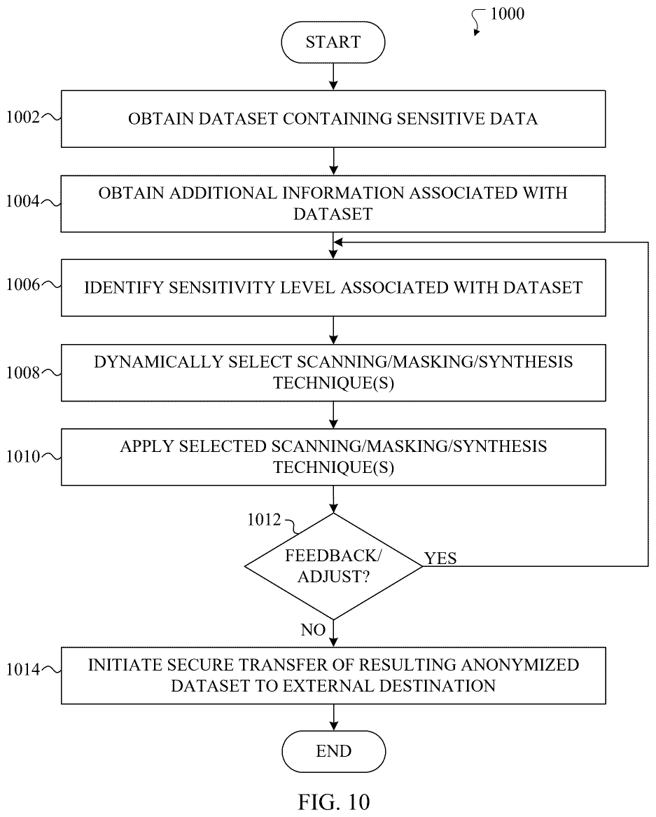

FIG. 10 illustrates an example method 1000 for using an adaptive data pipeline enabling a secure data transfer according to this disclosure. For ease of explanation, the method 1000 of FIG. 10 is described as being performed using the functional architecture 300 of FIG. 3, which may be implemented using the application server 106 of FIG. 1 (which itself may be implemented using one or more instances of the device 200 of FIG. 2). However, the method 1000 may be performed using any other suitable device(s) and in any other suitable system(s).

As shown in FIG. 10, a dataset containing sensitive data is obtained at step 1002. This may include, for example, the at least one processing device 202 of the application server 106 obtaining a dataset 114, 302 from any suitable source(s). Additional information associated with the dataset is obtained at step 1004. This may include, for example, the at least one processing device 202 of the application server 106 obtaining context/intent details 304 associated with the dataset 114, 302. As particular examples, the context/intent details 304 may include a context in which the dataset 114, 302 will be used (such as a type of application and/or a location), dataset details (such as a size of the dataset 114, 302 and/or a complexity of the dataset 114, 302), constraints (such as a processing speed requirement, whether a cost constraint exists, and/or whether synthetic data needs to retain statistical significance), and any known sensitivity of the dataset 114, 302. A sensitivity level associated with the dataset is identified at step 1006. This may include, for example, the at least one processing device 202 of the application server 106 using the data classification module 308 to identify an initial sensitivity level or other real-time data sensitivity score 310 for the dataset 114, 302.

Based on the sensitivity level and the additional information associated with the dataset, at least one of a scanning technique, a masking technique, and a synthesis technique is dynamically selected at step 1008. This may include, for example, the at least one processing device 202 of the application server 106 using the dynamic workflow orchestrator 312 to select at least one scanning technique, at least one masking technique, and/or at least one synthesis technique to be applied to the dataset 114, 302. As described above, part of this can involve using information in a dataset intake form (the table 400) to select at least one scanning technique (using the table 500), at least one masking technique (using the table 600), and/or at least one data synthesis technique (using the table 700). In some cases, the dynamic workflow orchestrator 312 may select all of at least one scanning technique, at least one masking technique, and/or at least one data synthesis technique. In some cases, the dynamic workflow orchestrator 312 may use one or more machine learning models to select the scanning/masking/synthesis technique(s). As a particular example, the machine learning model(s) or other logic may be used to select one or more sensitivity parameters for the scanning technique, the masking technique, and/or the synthesis technique.

The selected scanning/masking/synthesis technique(s) are applied at step 1010. This may include, for example, the at least one processing device 202 of the application server 106 using the dynamic scanning module 320 to perform the selected scanning technique(s), using the dynamic masking module 324 to perform the selected masking technique(s), and using the dynamic synthesis module 328 to perform the selected synthesis technique(s). As part of this, one or more decisions by the functional architecture 300 may be reviewed/confirmed by a human in the loop. A determination is made whether feedback is received that can cause adjustment within the functional architecture at step 1012. This may include, for example, the at least one processing device 202 of the application server 106 determining whether feedback 338-342 associated with the scanning, masking, and/or synthesis operations has been received. If feedback has been received and causes one or more adjustments to be needed, the process can return to an earlier step. In this example, the process returns to step 1006, where the sensitivity level may be adjusted (such as increased or decreased) based on the feedback. However, the process may also return to a different step, such as by returning to step 1008 so that the feedback can be used to adjust which scanning/masking/synthesis technique(s) are selected. This results in the generation of an updated scanned dataset, masked dataset, and/or anonymized dataset.

At some point, processing of the dataset completes, and an anonymized dataset 332 is available for use in any suitable manner. In this example, a secure data transfer of the anonymized dataset to an external destination is initiated at step 1014. This may include, for example, the at least one processing device 202 of the application server 106 initiating communication of the anonymized dataset 332 via a secure communication link to at least one external sandbox/destination 334 or other external environment 118. In some cases, approval of at least one user 336 may be needed prior to transferring the anonymized dataset 332.

Although FIG. 10 illustrates one example of a method 1000 for using an adaptive data pipeline enabling a secure data transfer, various changes may be made to FIG. 10. For example, while shown as a series of steps, various steps in FIG. 10 may overlap, occur in parallel, occur in a different order, or occur any number of times (including zero times). As a particular example, feedback may be received at different points, such as during scanning, masking, and/or synthesis, and each instance of feedback may be used to initiate repetition of one or more prior operations and/or to adjust one or more future operations.

It should be noted that the functions shown in or described with respect to FIGS. 1 through 10 can be implemented in an application server 106, user device 102a-102d, or other device(s) in any suitable manner. For example, in some embodiments, at least some of the functions shown in or described with respect to FIGS. 1 through 10 can be implemented or supported using one or more software applications or other software instructions that are executed by at least one processing device 202 of the application server 106, user device 102a-102d, or other device(s). In other embodiments, at least some of the functions shown in or described with respect to FIGS. 1 through 10 can be implemented or supported using dedicated hardware components. In general, the functions shown in or described with respect to FIGS. 1 through 10 can be performed using any suitable hardware or any suitable combination of hardware and software/firmware instructions. Also, the functions shown in or described with respect to FIGS. 1 through 10 can be performed by a single device or by multiple devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining a dataset;
identifying a sensitivity level associated with the dataset;
based on the sensitivity level and additional information associated with the dataset, dynamically selecting at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data; and
applying the at least one of the scanning technique, the masking technique, and the data synthesis technique during generation of an anonymized dataset, wherein the anonymized dataset lacks the sensitive information.

2. The method of claim 1, wherein all of the scanning technique, the masking technique, and the data synthesis technique are dynamically selected based on the sensitivity level and the additional information associated with the dataset.

3. The method of claim 2, wherein the scanning technique, the masking technique, and the data synthesis technique are dynamically selected using multiple machine learning models.

4. The method of claim 3, wherein the machine learning models are configured to select one or more sensitivity parameters for each of the scanning technique, the masking technique, and the data synthesis technique.

5. The method of claim 2, further comprising, after at least one of the scanning technique, the masking technique, and the data synthesis technique is selected and used to process the dataset:
receiving feedback to adjust at least one of the scanning technique, the masking technique, and the data synthesis technique; and
updating at least one of the anonymized dataset, a scanned dataset, or a masked dataset.

6. The method of claim 1, wherein the additional information associated with the dataset comprises at least one of:
a context in which the dataset will be used, including a type of application and a location;
dataset details, including a size of the dataset and a complexity of the dataset;
constraints, including a processing speed requirement, whether a cost constraint exists, and whether the synthetic data needs to retain statistical significance; and
any known sensitivity of the dataset.

7. The method of claim 1, further comprising:
communicating the anonymized dataset to an external destination, the external destination outside a computing environment in which the dataset is stored.

8. The method of claim 1, wherein at least one of:
the scanning technique is selected from a set of scanning techniques that includes: keyword-based scanning, pattern matching, heuristic-based scanning, natural language processing-based scanning, and differential privacy scanning;
the masking technique is selected from a set of masking techniques that includes: simple substitution masking, truncation masking, non-salted hashing masking, salted hashing masking, generalization masking, tokenization masking, dynamic data masking, differential privacy masking, and synthetic data generation masking; or
the data synthesis technique is selected from a set of data synthesis techniques that includes: shuffling data synthesis, noise injection data synthesis, data generalization data synthesis, attribute swapping data synthesis, synthetic data generation data synthesis, differential privacy scanning data synthesis, and generative adversarial network (GAN)-based data synthesis.

9. An apparatus comprising:
at least one processing device configured to:
obtain a dataset;
identify a sensitivity level associated with the dataset;
based on the sensitivity level and additional information associated with the dataset, dynamically select at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data; and
apply the at least one of the scanning technique, the masking technique, and the data synthesis technique during generation of an anonymized dataset, wherein the anonymized dataset lacks the sensitive information.

10. The apparatus of claim 9, wherein the at least one processing device is configured to dynamically select all of the scanning technique, the masking technique, and the data synthesis technique based on the sensitivity level and the additional information associated with the dataset.

11. The apparatus of claim 10, wherein the at least one processing device is configured to dynamically select the scanning technique, the masking technique, and the data synthesis technique using multiple machine learning models.

12. The apparatus of claim 11, wherein the machine learning models are configured to select one or more sensitivity parameters for each of the scanning technique, the masking technique, and the data synthesis technique.

13. The apparatus of claim 10, wherein the at least one processing device is further configured, after at least one of the scanning technique, the masking technique, and the data synthesis technique is selected and used to process the dataset, to:
receive feedback to adjust at least one of the scanning technique, the masking technique, and the data synthesis technique; and
update at least one of the anonymized dataset, a scanned dataset, or a masked dataset.

14. The apparatus of claim 9, wherein the additional information associated with the dataset comprises at least one of:
a context in which the dataset will be used, including a type of application and a location;
dataset details, including a size of the dataset and a complexity of the dataset;
constraints, including a processing speed requirement, whether a cost constraint exists, and whether the synthetic data needs to retain statistical significance; and
any known sensitivity of the dataset.

15. The apparatus of claim 9, wherein the at least one processing device is further configured to communicate the anonymized dataset to an external destination, the external destination outside a computing environment in which the dataset is stored.

16. The apparatus of claim 9, wherein at least one of:
the scanning technique is selected from a set of scanning techniques that includes: keyword-based scanning, pattern matching, heuristic-based scanning, natural language processing-based scanning, and differential privacy scanning;
the masking technique is selected from a set of masking techniques that includes: simple substitution masking, truncation masking, non-salted hashing masking, salted hashing masking, generalization masking, tokenization masking, dynamic data masking, differential privacy masking, and synthetic data generation masking; or
the data synthesis technique is selected from a set of data synthesis techniques that includes: shuffling data synthesis, noise injection data synthesis, data generalization data synthesis, attribute swapping data synthesis, synthetic data generation data synthesis, differential privacy scanning data synthesis, and generative adversarial network (GAN)-based data synthesis.

17. A non-transitory computer readable medium containing instructions that when executed cause at least one processor to:
obtain a dataset;
identify a sensitivity level associated with the dataset;
based on the sensitivity level and additional information associated with the dataset, dynamically select at least one of: (i) a scanning technique that defines how the dataset is scanned for sensitive information to be removed, (ii) a masking technique that defines how the sensitive information is to be removed, and (iii) a data synthesis technique that defines how the sensitive information is to be replaced with synthetic data; and
apply the at least one of the scanning technique, the masking technique, and the data synthesis technique during generation of an anonymized dataset, wherein the anonymized dataset lacks the sensitive information.

18. The non-transitory computer readable medium of claim 17, wherein the instructions when executed cause the at least one processor to dynamically select all of the scanning technique, the masking technique, and the data synthesis technique based on the sensitivity level and the additional information associated with the dataset.

19. The non-transitory computer readable medium of claim 18, wherein:
the instructions when executed cause the at least one processor to dynamically select the scanning technique, the masking technique, and the data synthesis technique using multiple machine learning models; and
the machine learning models are configured to select one or more sensitivity parameters for each of the scanning technique, the masking technique, and the data synthesis technique.

20. The non-transitory computer readable medium of claim 18, further containing instructions that when executed cause the at least one processor, after at least one of the scanning technique, the masking technique, and the data synthesis technique is selected and used to process the dataset, to:
receive feedback to adjust at least one of the scanning technique, the masking technique, and the data synthesis technique; and
update at least one of the anonymized dataset, a scanned dataset, or a masked dataset.
